(19) United States
(12) Patent Application Publication
(10) Pub. No.: US 2025/0136768 A1
(43) Pub. Date: May 1, 2025

(54) METHOD OF PREPARING WET MASTER BATCH ELASTOMER COMPOSITION FOR MAKING RUBBER WITH EXCELLENT PROCESSABILITY AND ABRASION RESISTANCE

(71) Applicant: KOREA KUMHO PETROCHEMICAL CO., LTD., Seoul (KR)

(72) Inventors: Seung Hyun KIM, Cheongju-si (KR); Jae Young KO, Daejeon (KR); Kyeongjun CHO, Daejeon (KR); Eunjoo KIM, Seoul (KR)

(73) Assignee: KOREA KUMHO PETROCHEMICAL CO., LTD., Seoul (KR)

(21) Appl. No.: 18/925,748

(22) Filed: Oct. 24, 2024

(30) Foreign Application Priority Data
Oct. 25, 2023 (KR) 10-2023-0144037

(51) Int. Cl. C08J 3/22; C08J 3/205; C08K 3/36

(52) U.S. Cl. CPC C08J 3/223; C08J 3/205; C08J 3/226; C08K 3/36; C08J 2309/06; C08K 2201/006

(57) ABSTRACT

Disclosed is a method of preparing a wet master batch elastomer composition, including: a first step of inputting silica particles and an organic silane coupling agent into a SSBR polymer solution; a second step of stirring the SSBR polymer solution containing the silica particles and the organic silane coupling agent to pulverize the silica particles while surface-modifying the silica particles with the organic silane coupling agent; a third step of removing a solvent from the SSBR polymer solution containing the surface-modified and pulverized silica particles, followed by drying and solidification to obtain a silica-SSBR composite; and a fourth step of compounding the silica-SSBR composite with one or more additives selected from the group consisting of silica particles, an organic silane coupling agent, a softener, a crosslinking activator, an antioxidant, a vulcanization accelerator, and a vulcanizing agent, wherein the wet master batch elastomer composition includes 8 to 20 parts by weight of the organic silane coupling agent based on 100 parts by weight of the SSBR polymer solution.

### BACKGROUND

### 1. Field of the Invention

The present specification relates to a method of preparing a wet master batch elastomer composition for making rubber with excellent processability and abrasion resistance.

### 2. Discussion of Related Art

Generally, tire treads are manufactured by mixing rubber and a filler in a mixer during the tire manufacturing process. The rubber used here is a mixture of a styrene butadiene copolymer and conjugated diene rubber, and carbon black or silica as a filler is used alone or in combination as a reinforcing material.

Silica is an eco-friendly material that is gaining attention as a tire reinforcing material (filler material) at a time when environmental regulations and high oil prices are continuously intensifying, and is a reinforcing material for “green tires,” which have recently become an issue, and its use is rapidly increasing and is attracting attention. However, in the case of silica used as a reinforcing material, agglomeration occurs due to the interaction between silica particles, causing the silica particles to agglomerate together to form large particles, making it difficult to disperse the silica by mixing it with rubber. Since the dispersion of silica in rubber has a significant impact on tire abrasion and tire service life, it is necessary to maximize silica dispersion during compounding.

Typically, to increase the dispersibility of reinforcing materials and simplify the tire manufacturing process, elastomers are often used in the form of master batches by mixing silica. However, when manufacturing an elastomer in the form of a silica master batch using a diene-based copolymer prepared by solution polymerization, there is a problem in that most of the silica is lost to water during the steam stripping process due to the hydrophilic nature of silica, and therefore there is a limit to commercially manufacturing an elastomer in the form of a silica master batch using a solution polymer.

Meanwhile, when hydrophobic silica is used as a tire reinforcing material, there is a problem in that it is difficult to obtain the mechanical properties required for the tire because chemical bonding with rubber is impossible. To maximize dispersibility and secure mechanical properties, various studies are being proposed to use silica more effectively.

U.S. Pat. No. 8,865,799 discloses a method of preparing a silica master batch by subjecting hydrophobic silica to organic treatment and stirring it with ESBR latex in a slurry state. However, since 5% alcohol is included in the organic treatment process, there is a disadvantage in that an additional purification process of water and alcohol is required after solvent recovery.

U.S. Pat. No. 7,312,271 discloses a method of preparing a silica master batch by dispersing silica in a solvent such as SSBR, which has the advantage of easy solvent recovery, but has the limitation that silica is lost to water during the stripping process due to the hydrophilicity of silica. In this case, a method of introducing silica (Ciptane® LP, PPG Industries, Inc.) that has already been organically treated can be implemented, but since a separate process for organically treating silica is required, not only does it increase the time and cost for manufacturing a silica-SSBR composite, it is also difficult to obtain results that satisfy the properties required for high-performance tires.

Therefore, there is a need for the development of an elastomer in the form of a silica master batch that can improve silica dispersibility and binding strength and realize excellent properties.

### RELATED ART DOCUMENTS

### Patent Documents

(Patent Document 0001) U.S. Pat. No. 8,865,799

(Patent Document 0002) U.S. Pat. No. 7,312,271

### SUMMARY OF THE INVENTION

One of the several objects of the present invention is to provide a method of preparing a wet master batch elastomer composition having improved silica dispersibility and binding strength.

Another object of the present invention is to provide a method of preparing a wet master batch elastomer composition suitable for preparing a rubber composition having excellent processability and abrasion resistance.

According to one aspect, there is provided a method of preparing a wet master batch elastomer composition, the method including: a first step of inputting silica particles and an organic silane coupling agent into a SSBR polymer solution; a second step of stirring the SSBR polymer solution containing the silica particles and the organic silane coupling agent to pulverize the silica particles while surface-modifying the silica particles with the organic silane coupling agent; a third step of removing a solvent from the SSBR polymer solution containing the surface-modified and pulverized silica particles, followed by drying and solidification to obtain a silica-SSBR composite; and a fourth step of compounding the silica-SSBR composite with one or more additives selected from the group consisting of silica particles, an organic silane coupling agent, a softener, a crosslinking activator, an antioxidant, a vulcanization accelerator, and a vulcanizing agent, wherein the wet master batch elastomer composition includes 8 to 20 parts by weight of the organic silane coupling agent based on 100 parts by weight of the SSBR polymer solution.

In one embodiment, a BET specific surface area of the silica particle input in the first step may be 20 to 300 m²/g.

In one embodiment, a ratio of an average particle diameter of the silica particles pulverized in the second step to an average particle diameter of the silica particles input in the first step may be 0.8 or less, preferably 0.5 or less, and more preferably 0.2 or less.

In one embodiment, the content of the bound rubber in the wet master batch elastomer composition may be 30 to 80 wt %, preferably 50 to 70 wt %.

In one embodiment, the stirring may be performed by a pulverizing type stirrer.

In one embodiment, in the stirring, the stirring speed may be 1,000 rpm or more, and the stirring time may be 0.1 to 60 minutes.

In one embodiment, the wet master batch elastomer composition may include 20 to 200 parts by weight of the silica particles based on 100 parts by weight of the SSBR polymer.

In one embodiment, the organic silane coupling agent may include a first organic silane compound represented by Chemical Formula 1 and a second organic silane compound represented by Chemical Formula 2:

(R₁O)₃—Si—R₂—S—R₃OR₄ [Chemical Formula 1]

(in Chemical Formula 1, R₁ and R₃ are aliphatic hydrocarbon groups having 1 to 4 carbon atoms, R₂ is an aliphatic hydrocarbon group having 3 to 8 carbon atoms, and R₄ is an aliphatic hydrocarbon group having 1 to 20 carbon atoms); and

(R₅O)₃—Si—R₆—(S)ₙ—R₆—Si—(OR₅)₃ [Chemical Formula 2]

(in Chemical Formula 2, R⁵ are each independently an aliphatic hydrocarbon group having 1 to 4 carbon atoms, R⁶ are each independently an aliphatic hydrocarbon group having 3 to 8 carbon atoms, and n is any integer from 1 to 4).

### DETAILED DESCRIPTION OF EXEMPLARY EMBODIMENTS

Hereinafter, one aspect of the present specification will be described. However, the description of the present specification may be implemented in several different forms, and thus is not limited to the embodiments described herein. In order to clearly illustrate the present invention, parts irrelevant to the description are omitted.

Throughout the present specification, when a part is said to “include” a component, this means that other components may be further included, not excluded, unless specifically stated otherwise.

When a range of numerical values is recited herein, the values have the precision of the significant figures provided in accordance with the standard rules in chemistry for significant figures, unless a specific range is otherwise stated. For example, 10 includes the range of 5.0 to 14.9, and 10.0 includes the range of 9.50 to 10.49.

### Method of Preparing Wet Master Batch Elastomer Composition

A method of preparing a wet master batch elastomer composition according to one aspect includes: a first step of inputting silica particles and an organic silane coupling agent into a SSBR polymer solution; a second step of stirring the SSBR polymer solution containing the silica particles and the organic silane coupling agent to pulverize the silica particles while surface-modifying the silica particles with the organic silane coupling agent; a third step of removing a solvent from the SSBR polymer solution containing the surface-modified and pulverized silica particles, followed by drying and solidification to obtain a silica-SSBR composite; and a fourth step of compounding the silica-SSBR composite with one or more additives selected from the group consisting of silica particles, an organic silane coupling agent, a softener, a crosslinking activator, an antioxidant, a vulcanization accelerator, and a vulcanizing agent.

The wet master batch elastomer composition includes 8 to 20 parts by weight, preferably to 18 parts by weight of the organic silane coupling agent based on 100 parts by weight of the SSBR polymer solution. For example, based on 100 parts by weight of the SSBR polymer solution, the organic silane coupling agent may be present in an amount of 8 parts by weight, 9 parts by weight, 10 parts by weight, 11 parts by weight, 12 parts by weight, 13 parts by weight, 14 parts by weight, 15 parts by weight, 16 parts by weight, 17 parts by weight, 18 parts by weight, 19 parts by weight, 20 parts by weight, or a value between two of these values, but is not limited thereto. When the content of the organic silane coupling agent satisfies the above range, the dispersion of silica is improved, the bonding strength between the rubber and the silica, i.e., the content of bound rubber, is increased, and as a result, the processability and abrasion resistance of the resulting rubber composition can be maximized. In contrast, when the content of the organic silane coupling agent is outside the above range, the loss rate and agglomeration rate of silica may increase, or the bonding strength between the SSBR polymer and silica may decrease, thereby deteriorating the properties of the wet master batch elastomer composition.

The organic silane coupling agent contained in the wet master batch elastomer composition may be entirely input in the first step, or some may be input in the first step and the remaining part may be input in the fourth step, but it may be preferable for the organic silane coupling agent to be entirely input in the first step in terms of processability and abrasion resistance of the rubber composition.

### <Step 1>

The solution styrene-butadiene rubber (SSBR) polymer may refer to rubber prepared by solution polymerizing a conjugated diene-based monomer and an aromatic vinyl monomer in an organic solvent.

The conjugated diene-based monomer may be one selected from the group consisting of 1,3-butadiene, 2,3-dimethyl-1,3-butadiene, 2-ethyl-1,3-butadiene, 1,3-pentadiene, isoprene, and a combination of two or more thereof, but is not limited thereto.

The aromatic vinyl monomer may be one selected from the group consisting of styrene, alpha methyl styrene, ethyl styrene, isopropyl styrene, halogenated styrene, and a combination of two or more thereof, but is not limited thereto.

The solvent used in the solution polymerization may be an aromatic, aliphatic, or cyclic compound-based solvent, and may be, for example, cyclohexane, toluene, normal hexane, normal heptane, and one or more selected therefrom, but is not limited thereto.

The term “master batch” used in this specification refers to a method in which a high concentration of additives are dispersed in advance during the preparation of a rubber compound, and by using this master batch method, the dispersion of the additives within the rubber matrix can be improved, thereby improving the properties of the rubber compound.

The master batch may be divided into a dry master batch (DMB) and a wet master batch (WMB). The dry master batch is prepared through a single process of inputting raw materials to a mixer and then mixing the raw materials. However, when the dry master batch is applied to high silica content, dispersibility may be reduced and a non-uniform silica mixture may be prepared. The wet master batch is prepared by mixing and agglomerating raw materials into a slurry, and can evenly disperse a high content of silica, thereby uniformly improving the processability, abrasion, and fuel efficiency characteristics of the rubber compound.

A wet master batch elastomer composition according to one aspect of the present specification can uniformly disperse a high content of silica particles by being prepared by a wet master batch method, and can improve the bonding strength with an SSBR polymer, thereby implementing excellent properties of a final rubber product.

The silica particle may be pure silica, and the BET specific surface area of the silica particle may be 20 to 300 m²/g, for example, 20 m²/g, 30 m²/g, 40 m²/g, 50 m²/g, 60 m²/g, 70 m²/g, 80 m²/g, 90 m²/g, 100 m²/g, 110 m²/g, 120 m²/g, 130 m²/g, 140 m²/g, 150 m²/g, 160 m²/g, 170 m²/g, 180 m²/g, 190 m²/g, 200 m²/g, 210 m²/g, 220 m²/g, 230 m²/g, 240 m²/g, 250 m²/g, 260 m²/g, 270 m²/g, 280 m²/g, 290 m²/g, 300 m²/g, or a value between two of these values, but is not limited thereto.

The content of the silica particles may be 20 to 200 parts by weight based on 100 parts by weight of the SSBR polymer. For example, the content may be 20 parts by weight, 30 parts by weight, 40 parts by weight, 50 parts by weight, 60 parts by weight, 70 parts by weight, 80 parts by weight, 90 parts by weight, 100 parts by weight, 110 parts by weight, 120 parts by weight, 130 parts by weight, 140 parts by weight, 150 parts by weight, 160 parts by weight, 170 parts by weight, 180 parts by weight, 190 parts by weight, 200 parts by weight, or a value between two of these values. When the content of silica particles is less than the above range, it may be difficult to expect the desired improvement in properties, and when it exceeds the above range, the silica loss rate may increase and the density may increase, which may cause difficulties in the process.

The organic silane coupling agent may impart hydrophobicity to the surface of silica particles when the silica particles are combined with the SSBR polymer, and thus the bonding strength between the SSBR polymer and the silica particles can be stably maintained, thereby preventing the loss of silica. In addition, re-agglomeration of silica particles may be prevented, allowing them to be dispersed in a stable state within the SSBR polymer matrix.

Here, it should be noted that the organic silane coupling agent is not input to the SSBR polymer solution in a pre-mixed state with the silica particles, but rather the organic silane coupling agent and the silica particles are separately input to the SSBR polymer solution. In the past, a wet master batch was prepared by pre-mixing the organic silane coupling agent and silica particles to treat the surface of the silica particles organically, and then inputting the organically treated silica to an SSBR polymer solution. However, the process of organically treating the surface of the silica particles took a long time and required a large amount of solvent, which was disadvantageous in the process. However, the present invention has the advantage of being able to reduce the overall process time by omitting the organic treatment process, as well as reducing the amount of solvent used, thereby significantly reducing manufacturing costs and energy usage.

As an example, the organic silane coupling agent may include a first organic silane compound represented by Chemical Formula 1 and a second organic silane compound represented by Chemical Formula 2:

(R₁O)₃—Si—R₂—S—R₃OR₄ [Chemical Formula 1]

(in Chemical Formula 1, R₁ and R₃ are aliphatic hydrocarbon groups having 1 to 4 carbon atoms, R₂ is an aliphatic hydrocarbon group having 3 to 8 carbon atoms, and R₄ is an aliphatic hydrocarbon group having 1 to 20 carbon atoms); and

(R₅O)₃—Si—R₆—(S)ₙ—R₆—Si—(OR₅)₃ [Chemical Formula 2]

(in Chemical Formula 2, R⁵ are each independently an aliphatic hydrocarbon group having 1 to 4 carbon atoms, R⁶ are each independently an aliphatic hydrocarbon group having 3 to 8 carbon atoms, and n is any integer from 1 to 4).

The first organic silane compound may include a thioester group (RCO—S—R′), and may include, for example, 3-octanoylthiopropyl triethoxysilane (NXT), but is not limited thereto.

The second organic silane compound may be selected from the group consisting of, for example, bis [3-(triethoxysilyl) propyl] tetrasulfide (TESPT), bis [3-(triethoxysilyl) propyl] disulfide (TESPD), and mixtures thereof, but is not limited thereto.

In particular, by using a mixture of the first organic silane compound and the second organic silane compound as organic silane coupling agents, silica loss and aggregation can be effectively prevented, thereby improving the properties of the wet master batch elastomer composition.

### <Step 2>

A second step of stirring the SSBR polymer solution including the silica particles and the organic silane coupling agent to pulverize the silica particles while surface-modifying the silica particles with the organic silane coupling agent may be performed. The second step may be a step in which, as silica particles are pulverized, bonding occurs between the pulverized silica particles and the organic silane coupling agent to form organic silica, and bonding occurs between the organic silica and rubber to form bound rubber.

As an example, the stirring and pulverizing may be performed by a pulverizing type stirrer. The pulverizing type stirrer is characterized by having an impeller inside, unlike a general stirrer that is intended for simple stirring and kneading. In the pulverizing type stirrer, the silica particles dispersed in the SSBR polymer solution are pulverized as they pass between rotating impellers. The impeller types include a paddle type, propeller type, turbine type, anchor type, or helical type, but are not limited thereto.

As an example, in the second step, the stirring speed may be 1,000 rpm or more. For example, the stirring speed may be 1,000 rpm or more, 1,100 rpm or more, 1,200 rpm or more, 1,300 rpm or more, 1,400 rpm or more, 1,500 rpm or more, 1,600 rpm or more, 1,700 rpm or more, 1,800 rpm or more, 1,900 rpm or more, 2,000 rpm or more, 2,100 rpm or more, 2,200 rpm or more, 2,300 rpm or more, 2,400 rpm or more, 2,500 rpm or more, 2,600 rpm or more, 2,700 rpm or more, 2,800 rpm or more, 2,900 rpm or more, or 3,000 rpm or more, but is not limited thereto. When the stirring speed is less than 1000 rpm, the silica may not be sufficiently pulverized, which may result in a decrease in the dispersibility of the silica and a decrease in the bonding strength with the SSBR polymer.

As an example, in the second step, the stirring time may be from 0.1 to 60 minutes. For example, the stirring time may be 0.1 minutes, 0.2 minutes, 0.3 minutes, 0.4 minutes, 0.5 minutes, 0.6 minutes, 0.7 minutes, 0.8 minutes, 0.9 minutes, 1 minute, 2 minutes, 3 minutes, 4 minutes, 5 minutes, 6 minutes, 7 minutes, 8 minutes, 9 minutes, 10 minutes, 11 minutes, 12 minutes, 13 minutes, 14 minutes, 15 minutes, 16 minutes, 17 minutes, 18 minutes, 19 minutes, 20 minutes, 21 minutes, 22 minutes, 23 minutes, 24 minutes, 25 minutes, 26 minutes, 27 minutes, 28 minutes, 29 minutes, 30 minutes, 31 minutes, 32 minutes, 33 minutes, 34 minutes, 35 minutes, 36 minutes, 37 minutes, 38 minutes, 39 minutes, 40 minutes, 41 minutes, 42 minutes, 43 minutes, 44 minutes, 45 minutes, 46 minutes, 47 minutes, 48 minutes, 49 minutes, 50 minutes, 51 minutes, 52 minutes, 53 minutes, 54 minutes, 55 minutes, 56 minutes, 57 minutes, 58 minutes, 59 minutes, 60 minutes, or a value between two of these values. When the stirring time is outside the above range, the silica may not be sufficiently pulverized, which may result in a decrease in the dispersibility of the silica and a decrease in the bonding strength with the SSBR polymer.

As an example, the silica particles may cause physical adsorption of the SSBR polymer particles into the pores within the silica particles by stirring in the second step. Accordingly, the physical bonding strength between the SSBR polymer and the silica particles may increase. In addition, the silica particles are pulverized by stirring, so that when input, the average particle size of the silica decreases, and as the surface area of the silica particles increases, a large amount of silanol groups are generated, and their active sites increase, so that chemical bonding with the SSBR polymer may increase. That is, the silica particles may simultaneously form physical bonds and chemical bonds with the SSBR polymer due to stirring and pulverizing in the second step, thereby effectively increasing the content of bound rubber in the wet master batch elastomer composition.

As an example, the ratio of the average particle diameter of the pulverized silica particle to the average particle diameter of the silica particle may be 0.8 or less, for example, 0.8 or less, 0.7 or less, 0.6 or less, preferably 0.5 or less, 0.4 or less, 0.3 or less, more preferably 0.2 or less, 0.1 or less, 0.09 or less, 0.08 or less, 0.07 or less, 0.06 or less, or 0.05 or less, but is not limited thereto. Meanwhile, the average particle diameter of the pulverized silica particle is not particularly limited, but for example, may be an average particle diameter on the nanometer scale. As the ratio of the average particle diameter of the silica particle decreases, the content and particle size of the pulverized silica particle decrease, which means that the bonding strength with the SSBR polymer may increase.

As an example, the content of the bound rubber in the wet master batch elastomer composition may be 30 to 80 wt %, preferably 50 to 70 wt %. For example, the content may be 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, or a value between two of these values. When the content of bound rubber is outside the above range, the bonding strength between the SSBR polymer and the silica particles may be reduced, and the miscibility with other mixtures may be reduced.

### <Step 3>

A third step of removing a solvent from the SSBR polymer solution containing the surface-modified and pulverized silica particles, followed by drying and solidification to obtain a silica-SSBR composite may be performed.

At this time, the solvent may be removed by a stripping process, a devolatilization process, or a roll drying process, but is not limited thereto.

In addition, the drying may be performed at a temperature at 100° C. or lower, but is not limited thereto.

Meanwhile, prior to drying after solvent removal, a process of forming the solids from which the solvent has been removed into a pellet or bale shape may be additionally included, but is not limited thereto.

### <Step 4>

A fourth step of compounding the silica-SSBR composite with one or more additives selected from the group consisting of an organic silane coupling agent, an inorganic filler, a softener, a crosslinking activator, an antioxidant, a vulcanization accelerator, and a vulcanizing agent may be performed.

The inorganic filler may be one or more selected from the group consisting of silica and carbon black, but is not limited thereto.

The softener is added to impart plasticity to rubber to facilitate processing or to reduce the hardness of vulcanized rubber, and refers to oils or other materials used during rubber compounding or rubber preparation. The softener refers to processing oil or other oils included in a rubber composition. The softener may be any one selected from the group consisting of petroleum oil, vegetable oil, and a combination thereof, but the present invention is not limited thereto. The oil used as the softener is preferably a TDAE oil having a total PAHs content of 3 wt % or less based on the entire oil, a kinematic viscosity of 95 or more (210° F. SUS), 15 to 25 wt % of an aromatic component in the softener, 27 to 37 wt % of a naphthenic component, and 38 to 58 wt % of a paraffinic component, but is not limited thereto. The TDAE oil imparts excellent low-temperature characteristics and excellent fuel efficiency to tire treads including the TDAE oil, and also has favorable characteristics with respect to environmental factors such as the carcinogenic potential of PAHs.

The crosslinking activator is added to further promote the crosslinking reaction, and may reduce the amount of the vulcanizing agent and vulcanization accelerator added. The crosslinking activator may be stearic acid and zinc oxide (ZnO), but is not limited thereto.

The antioxidant may be selected from the group consisting of N-(1,3-dimethylbutyl)-N′-phenyl-p-phenylenediamine (6PPD), N-phenyl-N′-isopropyl-p-phenylenediamine, N,N′-diphenyl-p-phenylenediamine (3PPD), 2,2,4-trimethyl-1,2-dihydroquinoline (RD), and a combination thereof, but is not limited thereto.

The vulcanizing agent may include a sulfur vulcanizing agent. The sulfur vulcanizing agent may be elemental sulfur or a sulfur-generating vulcanizing agent, such as amine disulfide or polymeric sulfur, and is preferably elemental sulfur, but is not limited thereto.

The vulcanization accelerator may be selected from the group consisting of amine, disulfide, guanidine, thio, urea, thiazole, thiuram, sulfene amide, and a combination thereof, but is not limited thereto.

Meanwhile, a method of preparing the wet master batch elastomer composition may further include a step of adding reaction accelerators, antioxidants, heat stabilizers, light stabilizers, anti-ozonants, processing aids, plasticizers, adhesives, swelling agents, dyes, pigments, waxes, extenders, organic acids, retardants, metal oxides, activators, and the like known in the rubber industry to produce a molded or extruded product of the wet master batch elastomer composition.

The wet master batch elastomer composition may be used for cable coverings, hoses, drive belts, conveyor belts, roll covers, shoe soles, gaskets, braking elements, and tires, and may be particularly suitable for use as tire treads.

When the wet master batch elastomer composition according to the above-described preparation method is used as a tire material, not only can the mechanical and abrasion resistance properties be improved compared to the performance of conventional silica tires, but also the silica dust problem during compounding can be solved. In addition, the compounding time of the tire may be shortened, and the processability of the tire and the dispersibility of silica may be improved.

Hereinafter, examples of the present specification will be described in more detail. However, the following experimental results describe only representative experimental results among the examples, and the scope and content of the present invention may not be interpreted as being reduced or limited by the examples. Each effect of the various implementations of the present invention not explicitly presented below will be specifically described in the corresponding section.

### EXAMPLE 1

150 g of styrene, 438 g of 1,3-butadiene, and 3,600 g of cyclohexane were input to a 10 L stainless steel reactor, and then 0.5 g of ditetrahydrofuryl propane was input to the reactor. After the input was completed, an internal temperature of the reactor was adjusted to 35° C. while the general stirrer was rotated at a stirring speed of 100 rpm. Next, 2.4 mmol of n-butyllithium was input to the reactor and an adiabatic temperature-raising reaction was performed. After the reaction temperature reached the maximum temperature of about 100° C., 12 g of 1,3-butadiene was additionally input to substitute the reaction terminal with butadiene to prepare a styrene-butadiene rubber (solution styrene butadiene rubber; SSBR) polymer solution.

Next, an organic silane coupling agent mixed with 100 parts by weight of silica particles, 2 parts by weight of 3-octanoylthiopropyl triethoxysilane (NXT), and 4 parts by weight of bis[3-(triethoxysilyl)propyl]tetrasulfide (TESPT) based on 100 parts by weight of the styrene-butadiene rubber polymer was mixed with the styrene-butadiene rubber polymer solution, and then the mixture was stirred in a pulverizing type stirrer at a stirring speed of 2,000 rpm for 10 minutes. Afterward, the solvent was removed by a stripping process, the product was formed into a pellet form, and dried at a temperature of 80° C. to prepare a silica-SSBR composite. At this time, the silica particles used were pure silica with a BET specific surface area of 200 m²/g.

Next, 40 parts by weight of TDAE oil as a softener, 3 parts by weight of zinc oxide (ZnO) and 2 parts by weight of stearic acid as crosslinking activators, 1 part by weight of N-(1,3-dimethylbutyl)-N′-phenyl-p-phenylenediamine (6PPD) as an antioxidant, 4.5 parts by weight of TESPT as an organic silane coupling agent, and 8 parts by weight of N330 (trade name; prepared by Cabot Japan) as an inorganic filler (carbon black) were input to the silica-SSBR composite and thoroughly mixed.

Next, 0.75 parts by weight of sulfur as a crosslinking agent, 2.2 parts by weight of N-cyclohexyl-2-benzothiazole sulfenamide (CBS) as a vulcanization accelerator, and 1.5 parts by weight of diphenyl guanidine (DPG) were input and stirred sufficiently to prepare a wet master batch (WMB).

### EXAMPLE 2

A wet master batch was prepared in the same manner as in Example 1, except that when mixing silica particles and an organic silane coupling agent with a styrene-butadiene rubber polymer solution, 4 parts by weight of NXT and 4 parts by weight of TESPT were mixed, and when mixing a silica-SSBR composite and an additive, 2.5 parts by weight of TESPT was mixed.

### EXAMPLE 3

A wet master batch was prepared in the same manner as in Example 1, except that when mixing silica particles and an organic silane coupling agent with a styrene-butadiene rubber polymer solution, 6.5 parts by weight of NXT and 4 parts by weight of TESPT were mixed, and when mixing a silica-SSBR composite and an additive, the organic silane coupling agent was not mixed.

### Comparative Example 1

A dry master batch was prepared in the same manner as in Example 1, but a dry master batch preparation method was used. Specifically, 100 parts by weight of silica, 40 parts by weight of TDAE oil as rubber compounding oil, 3 parts by weight of zinc oxide (ZnO) and 2 parts by weight of stearic acid as crosslinking activators, 1 part by weight of N-(1,3-dimethylbutyl)-N′-phenyl-p-phenylenediamine (6PPD) as an antioxidant, 10.5 parts by weight of TESPT as an organic silane coupling agent, and 8 parts by weight of N330 as an inorganic filler (carbon black) were input to 100 parts by weight of the SSBR polymer and thoroughly mixed.

Next, 0.75 parts by weight of sulfur as a crosslinking agent, 2.2 parts by weight of N-cyclohexyl-2-benzothiazole sulfenamide (CBS) as a vulcanization accelerator, and 1.5 parts by weight of diphenyl guanidine (DPG) were input and stirred sufficiently to prepare a dry master batch (DMB). At this time, silica may be additionally input during compounding, taking into account the amount of loss.

### Experimental Example

For the wet master batch elastomer compositions prepared in Examples 1 to 3 and the dry master batch elastomer composition prepared in Comparative Example 1, the content of bound rubber was measured by the method below, and the compounding processability, properties after compounding, and dynamic characteristics were evaluated, and the results are shown in Table 1.

### [Method for Measuring Bound Rubber Content]

After being maintained at room temperature (about 25° C.) for 7 days for conditioning, about 0.5 g of the sample was immersed in 100 ml of toluene (about 25° C.). After 7 days, it was taken out of toluene and dried in a vacuum until it reached a constant weight. The bound rubber content was measured by the following equation:

[Bound rubber content (wt %)]=(MB−MF−MD)/MB×100

(where MB represents the weight (g) of the master batch before immersion in toluene, MF represents the weight (g) of the filler contained in the master batch, and MD represents the weight (g) of the rubber dissolved in toluene).

### [Property Evaluation Method]

Compound Mooney viscosity: The Mooney viscosity of polymers and mixtures was measured using a Mooney viscometer.
Hardness: measured using a SHORE-A hardness tester.
Tensile strength, 300% modulus, elongation, toughness, and dispersibility: measured according to ASTM 3189 Method B using a universal test machine (UTM).
Abrasion resistance (DIN/Lambourn): Abrasion loss was analyzed using a DIN abrasion tester and a Lambourn abrasion tester, respectively.
Dynamic property value of vulcanized rubber (Tan δ): Wet traction and fuel efficiency properties were analyzed using a DMTA 5 device from Rheometic Scientific Co. under conditions of 10 Hz frequency and 0.1% strain.

TABLE 1

| | | | | Comparative |
|---|---|---|---|---|
| Classification | Example 1 | Example 2 | Example 3 | Example 1 |
| Bound rubber content | 54 | 58 | 64 | 48 |
| (wt %) | | | | |
| Processability | 130 | 135 | 156 | 100 |
| (Compound Mooney | | | | |
| viscosity, Compound | | | | |
| MV) | | | | |
| Hardness (Shore-A | 96 | 94 | 88 | 100 |
| Hardness) | | | | |
| 300% Modulus | 110 | 105 | 120 | 100 |
| Tensile strength | 101 | 103 | 119 | 100 |
| Elongation | 94 | 118 | 101 | 100 |
| Toughness | 94 | 127 | 119 | 100 |
| Dispersibility (Payne | 261 | 348 | 653 | 100 |
| Effect) | | | | |
| Abrasion resistance | 120 | 124 | 267 | 100 |
| (DIN) | | | | |
| Abrasion resistance | 127 | 133 | 114 | 100 |
| (Lambourn) | | | | |
| Wet traction | 111 | 114 | 132 | 100 |
| Fuel efficiency (RR) | 91 | 92 | 113 | 100 |

(Index value: The higher the value, the better the properties)

Referring to Table 1, it can be confirmed that the wet master batch elastomer compositions of Examples 1 to 3 not only have a higher bound rubber content than the dry master batch elastomer composition of Comparative Example 1, but also have improved silica dispersibility and mechanical properties. In particular, it can be confirmed that Example 3 has remarkably excellent processability and abrasion resistance, which is expected to be due to the significantly increased silica dispersibility and bonding strength with the SSBR polymer. In addition, Example 3 showed significantly improved wet traction and fuel efficiency compared to Comparative Example 1.

According to a method of preparing a wet master batch elastomer composition of the present invention, surface modification of silica is simultaneously performed in the process of pulverizing silica, and as a result, there is an advantage in that the dispersibility of silica particles and the bonding strength with rubber can be improved without using organic silica or performing a separate step of performing organic treatment of silica. In particular, since pre-treatment steps such as organic treatment can be omitted while using pure silica, the amount of solvent used and the overall process time can be reduced, thereby drastically reducing process costs.

In addition, the wet master batch elastomer composition obtained by the method of the present invention can be preferably applied to the preparation of a rubber composition having excellent processability and abrasion resistance.

The effects of one aspect of the present specification is not limited to the above-described effects, and it should be understood to include all effects that can be inferred from the configuration described in the detailed description or claims of the present specification.

The description of the present specification described above is for illustrative purposes, and it should be understood that those of ordinary skill in the art to which one aspect of the present specification belongs can easily modify it into other specific forms without changing the technical idea or essential features described in this specification. Therefore, it should be understood that the embodiments described above are illustrative in all respects and not restrictive. For example, each component described as a single type may be implemented in a distributed form, and likewise components described as distributed may be implemented in a combined form.

The scope of the present specification is indicated by the following claims, and all changes or modifications derived from the meaning and scope of the claims and their equivalents should be construed as being included in the scope of the present specification.

What is claimed is:

1. A method of preparing a wet master batch elastomer composition, comprising:
a first step of inputting silica particles and an organic silane coupling agent into a SSBR polymer solution;
a second step of stirring the SSBR polymer solution containing the silica particles and the organic silane coupling agent to pulverize the silica particles while surface-modifying the silica particles with the organic silane coupling agent;
a third step of removing a solvent from the SSBR polymer solution containing the surface-modified and pulverized silica particles, followed by drying and solidification to obtain a silica-SSBR composite; and
a fourth step of compounding the silica-SSBR composite with one or more additives selected from the group consisting of silica particles, an organic silane coupling agent, a softener, a crosslinking activator, an antioxidant, a vulcanization accelerator, and a vulcanizing agent, wherein the wet master batch elastomer composition includes 8 to 20 parts by weight of the organic silane coupling agent based on 100 parts by weight of the SSBR polymer solution.

2. The method of claim 1, wherein a BET specific surface area of the silica particle input in the first step is 20 to 300 m²/g.

3. The method of claim 1, wherein a ratio of an average particle diameter of the silica particles pulverized in the second step to an average particle diameter of the silica particles input in the first step is 0.8 or less.

4. The method of claim 3, wherein the ratio of the average particle diameter of the silica particles pulverized in the second step to the average particle diameter of the silica particles input in the first step is 0.5 or less.

5. The method of claim 4, wherein the ratio of the average particle diameter of the silica particles pulverized in the second step to the average particle diameter of the silica particles input in the first step is 0.2 or less.

6. The method of claim 1, wherein a content of bound rubber in the wet master batch elastomer composition is 30 to 80 wt %.

7. The method of claim 6, wherein the content of the bound rubber in the wet master batch elastomer composition is 50 to 70 wt %.

8. The method of claim 1, wherein the stirring is performed by a pulverizing type stirrer.

9. The method of claim 8, wherein a stirring speed in the stirring is 1,000 rpm or more.

10. The method of claim 8, wherein a stirring time in the stirring is 0.1 to 60 minutes.

11. The method of claim 1, wherein the wet master batch elastomer composition includes 20 to 200 parts by weight of the silica particles based on 100 parts by weight of the SSBR polymer.

12. The method of claim 1, wherein the organic silane coupling agent includes a first organic silane compound represented by Chemical Formula 1 and a second organic silane compound represented by Chemical Formula 2:
(R₁O)₃—Si—R₂—S—R₃OR₄ [Chemical Formula 1]
(in Chemical Formula 1, R₁ and R₃ are aliphatic hydrocarbon groups having 1 to 4 carbon atoms, R₂ is an aliphatic hydrocarbon group having 3 to 8 carbon atoms, and R₄ is an aliphatic hydrocarbon group having 1 to 20 carbon atoms); and
(R₅O)₃—Si—R₆—( S)ₙ—R₆—Si—(OR₅)₃ [Chemical Formula 2]
(in Chemical Formula 2, R⁵ are each independently an aliphatic hydrocarbon group having 1 to 4 carbon atoms, R⁶ are each independently an aliphatic hydrocarbon group having 3 to 8 carbon atoms, and n is any integer from 1 to 4).
